(19) United States
(12) Patent Application Publication
(10) Pub. No.: US 2006/0170741 A1
(43) Pub. Date: Aug. 3, 2006

(54) Method of refilling ink in an ink cartridge for an inkjet printer

(76) Inventors: Yong-Soo Lee, Gangnam-gu (KR); So-Yeon Lee, Gangnam-gu (KR)

Correspondence Address: MCKEE, VOORHEES & SEASE, P.L.C., 801 GRAND AVENUE, SUITE 3200, DES MOINES, IA, 50309-2721, US

(21) Appl. No.: 10/539,466

(22) PCT Filed: Jul. 22, 2003
(86) PCT No.: PCT/KR03/01448

§ 371 Date: Oct. 12, 2005

(30) Foreign Application Priority Data
Dec. 20, 2002 (KR) 10-2002-0081840

(51) Int. Cl. B41J 2/175

(52) U.S. Cl. 347/86

(57) ABSTRACT

Disclosed is an ink refill device. In the ink refill device, the main body is provided with a receiving space for receiving an ink cartridge therein, and first ink injecting part through which ink passes is provided on one outer side wall thereof. An ink injector is provided with second ink injecting part corresponding to the first ink injecting part so that ink is injected into the ink cartridge. Further, an ink absorber is provided in the main body neighboring the first ink injecting part to be closely contacted to an ink nozzle so that it absorbs ink being leaked from the ink nozzle. Whereby, a user, the surroundings or the ink cartridge can be prevented from being soiled.

### TECHNICAL FIELD

The present invention relates to a method of refilling ink, and more particularly to a method of refilling ink in an ink cartridge for an inkjet printer enabling to perfectly refill ink as much as an exhausted amount by forming an ink injecting hole on a predetermined position of the ink cartridge and by naturally discharging ink bubbles being generated due to the ink being injected into the ink cartridge.

### BACKGROUND ART

Recently, personal computers as much as industrial computers are widely used. Specifically, personal computers are used in lots of homes as much as offices. And, as a peripheral device to be used with a computer, various types of printers are widely used.

With this reason, many factories, which manufacture printers, researching and developing printers to provide better printing quality and ink cartridges to be used in the printers as expendable supplies. One of those ink cartridges, there is an ink cartridge made in EPSON company.

The ink cartridge as a whole comprises four individual cartridges, each individual cartridge is filled with black, blue, red and yellow colored ink, and each individual cartridge can be changed only by another exhausted ink cartridge. The company wants to save expenses to be required to change an ink cartridge.

Further, in this ink cartridge, an integrated circuit chip, to give and take information such as an exhaustion of ink to a computer, is built in. Therefore, users can check the remaining amount of ink by checking a monitor connected to a computer and can easily check a warning message, which inform there is a shortage of ink.

In this ink cartridge, on the inner structure thereof and on the design structure of an ink-jet printer using the ink cartridge, if a predetermined amount of ink is exhausted, not whole of ink, the ink-jet printer sends a signal to warn there is a shortage of ink to a monitor and thereby it stops to operate.

It is schematically shown in FIG. 3 the outer shape of the ink cartridge. And, it is schematically shown in FIG. 4 the inner structure of the ink cartridge.

As shown in FIGS. 3 and 4, the ink cartridge 30 comprises the cover 31 thereof for covering the main body 35 thereof, the ink discharging hole 34 being formed on the side surface of the main body 35 thereof and for discharging ink to a printer, the ink inserting hole 32 for initially inserting ink into the ink cartridge 30, the ink injecting hole 33 for refilling ink and the integrated circuit chip 38 for sending information regarding exhausted amount of ink. Here, the ink inserting hole 32 and the ink injecting hole 33 are covered with the vinyl cover 39.

Further, the cyclone type ink path 37 for discharging ink is formed in the intermediate portion of the inner of the ink cartridge 30. The path 37 saves ink and discharges a constant amount of ink.

The ink cartridge 30 may not be used if a predetermined amount of ink is exhausted, therefore it should be often refilled with ink. When ink is being refilled into the ink cartridge 30, the ink is injected into the ink cartridge 30 after inserting an ink injector into the ink inserting hole 32.

However, the method of refilling ink has a problem in which lots of ink bubbles occur during the refilling due to a complicated inner structure of the ink cartridge and due to the cyclone type ink path 37. That is, since the ink being refilled flows in a straight path and a curved path, the flowing speed of the ink changes. And, the change in the flowing speed causes bubbles to occur in the ink. Further, lots of ink bubbles occur just before the ink enters into the cyclone type ink path 37.

Thereby, the ink as much as the exhausted amount can not be perfectly refilled since it can not refill into the space corresponding with the amount of ink bubbles.

A printer is driven by a method in which a shortage of ink is automatically sensed only if a predetermined amount of ink is exhausted. If the printer use an incompletely refilled ink cartridge, it can not sense the shortage of ink even if the refilled ink has already exhausted. Therefore, the nozzle of the printer may be blocked, by the lack of refilled ink.

### DISCLOSURE OF INVENTION

The present invention has been developed to solve the above-mentioned problems. It is an object of the present invention to provide a method of refilling ink in an ink cartridge for an inkjet printer enabling to completely refill ink in an ink cartridge as much as the exhausted amount by forming an ink bubbles discharging hole on a predetermined position of the ink cartridge, and thereby effectively outwardly discharging the ink bubbles which occur when ink is being refilled into the ink cartridge.

To achieve the above object of the present invention, the present invention provides a method of refilling ink in an ink cartridge for an inkjet printer, the method comprising:

a step to remove a vinyl cover which covers an ink injecting hole formed on one side of the main body of the ink cartridge (step 1);

a step to insert a rubber cork into the open ink injecting hole (step 2);

a step to form an ink bubbles discharging hole on a predetermined position of a cover of the ink cartridge which covers the main body of the ink cartridge (step 3);

a step to slowly inject ink into the ink cartridge after inserting a needle of an ink injector into the rubber cork which is inserted in the ink injecting hole and (step 4); and

a step to extract the ink injector from the rubber cork after sealing the ink bubbles discharging hole formed on the cover with a predetermined sealing cork (step 5).

In the method of the present invention, step 5, to seal the ink bubbles discharging hole, is performed at the time when the ink is fully refilled in the ink cartridge and it is discharged to the outside.

### BRIEF DESCRIPTON OF DRAWINGS

Other features and advantages of the present invention will become more apparent from the following description taken in connection with the accompanying drawings, wherein:

FIG. 1 is a flow chart showing a method of refilling ink in an ink cartridge for an inkjet printer according to a preferred embodiment of the present invention;

FIG. 2 is a schematic view showing a state to perform the method of FIG. 1;

FIG. 3 is a schematic view showing an outer shape of an ink cartridge in a prior art; and

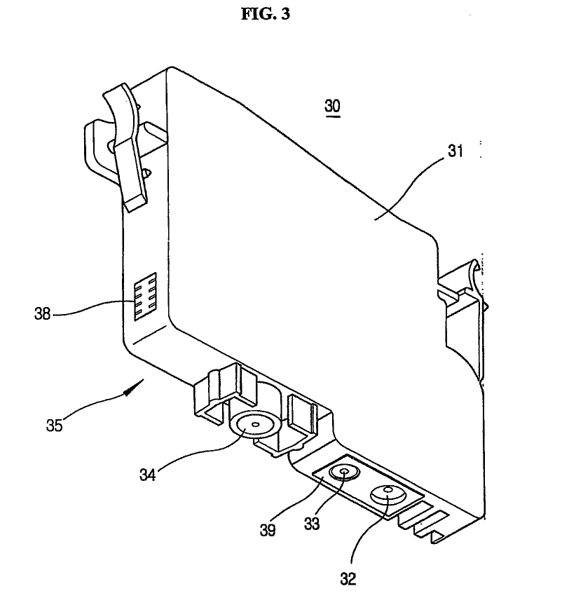

FIG. 4 is a schematic view showing the inner structure of the ink cartridge shown in FIG. 3.

### BEST MODE FOR CARRYING OUT THE INVENTION

Hereinafter, the method of refilling ink in an ink cartridge for an inkjet printer according to the preferred embodiment of the present invention will be described in detail with reference to the accompanying drawings.

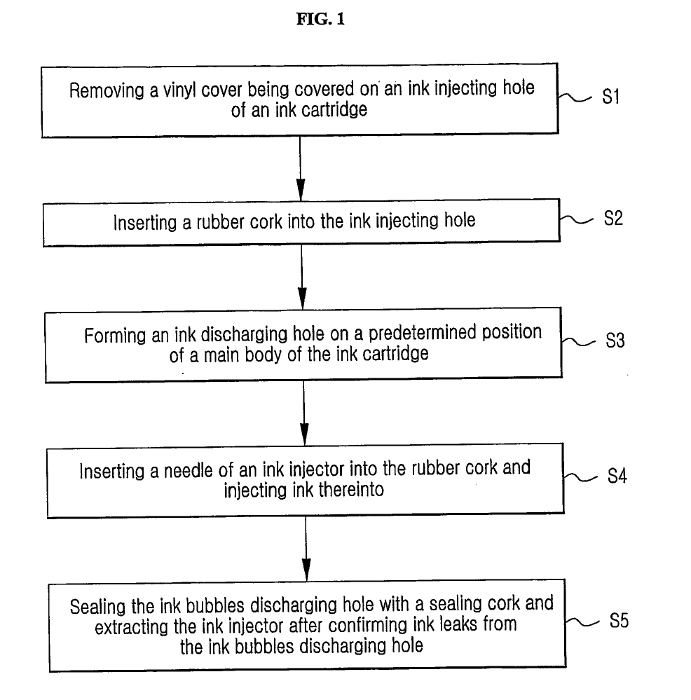

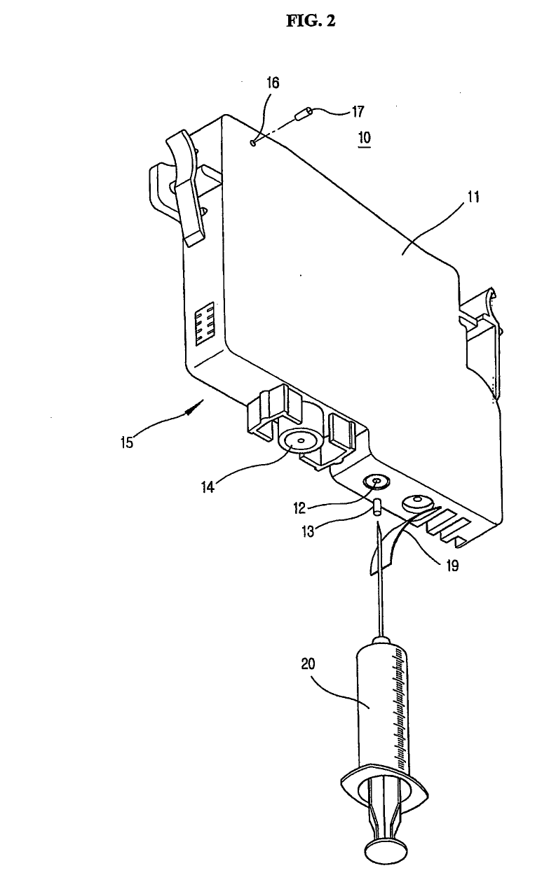

As shown in FIGS. 1 and 2, in the method according to the preferred embodiment of the present invention, firstly, the vinyl cover 19, which is cover on the ink injecting hole 12 formed on one side of the main body 15 of the ink cartridge at the time of being manufactured, is removed (S 1).

Afterward, the rubber cork 13 having a size corresponding to the inner size of the ink injecting hole 12 is tightly inserted into the ink injecting hole 12 from which the vinyl cover 19 is removed (S 2). At this time, the rubber cork 13 is preferably tightly jammed to the ink injecting hole 12. Thereby, the rubber cork 13 is not extracted from the ink injecting hole 12 while the needle of the ink injector 20 pierced into and extracts from the rubber cork 13.

Thereby, although the ink injector 20 is repeatedly inserted into the rubber cork 13, airtightness between the ink injecting hole 12 and the rubber cork 13.

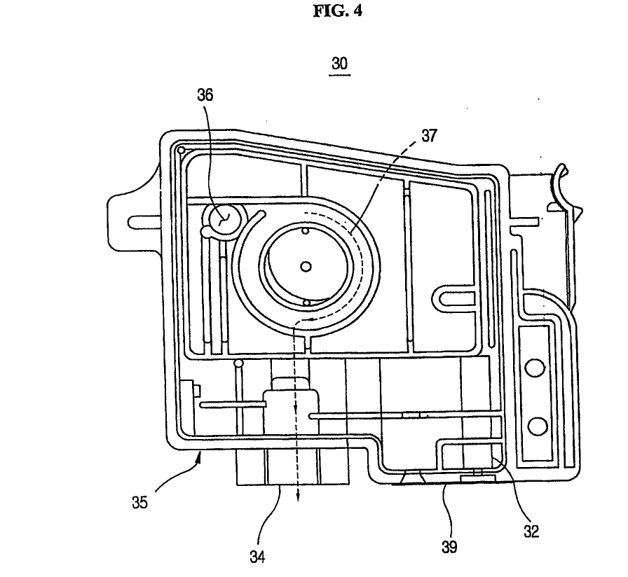

Afterward, the ink bubbles discharging hole 16 is formed on a predetermined position of the main body 15 of the ink cartridge by a predetermined drill (S 3). As shown the inner structure of the ink cartridge in FIG. 4, the position on which the ink bubbles discharging hole 16 is formed is directly above the sponge 36 which is also close to the cyclone type ink path (37 of FIG. 4). The position coincides with the place in which the ink bubbles, which occurs due to air being injected with the ink may be swiftly and certainly removed.

Thereby, the ink bubbles occurring in the ink cartridge 10 during the refill of ink may be perfectly removed. Therefore, it is possible that the ink cartridge 10 is refilled with ink as much as the exhausted amount.

Next, the needle of the ink injector 20 is inserted into the rubber cork 13 which is inserted to the ink injecting hole 12 and ink is slowly refilled in the ink cartridge 10. While refilling ink, lots of ink bubbles occur due to the complicated inner structure of the ink cartridge 10.

The ink bubbles are pushed and moved to the ink path (37 of FIG. 4) by the continually injected ink, and they are discharged to the outside of the ink cartridge 10 through the ink bubbles discharging hole 16 formed on the cover 11 of the ink cartridge.

Finally, after it is confirmed that the ink is discharged through the ink bubbles discharging hole 16 formed on the cover 11 of the ink cartridge, the ink bubbles discharging hole 16 is sealed with the sealing cork 17. Afterward, the ink injector 20 is extracted from the rubber cork 13 and the process to refill ink into the ink cartridge 10 is completed (S 5).

According to the method of the preferred embodiment for the present invention, the ink cartridge may be refilled with ink as much as the exhausted amount. Therefore, the ink cartridge may be used without any risk. Thereby, the nozzle of an ink-jet printer being connected to the ink cartridge is prevented from being blocked. Therefore, damage to the ink-jet printer by this method can be prevented.

Further, the ink cartridge can be repeatedly reused by inserting the rubber cork into the ink injecting hole. Therefore, the expense to buy new ink cartridges will be greatly saved.

While the present invention has been particularly shown and described with reference to particular embodiments thereof, it will be understood by those skilled in the art that various changes in form and details may be effected therein without departing from the spirit and scope of the invention as defined by the appended claims.

1. A method of refilling ink in an ink cartridge for an inkjet printer; the method comprising:
(S1) a step to remove a vinyl cover which is covered on an ink injecting hole formed on one side of the main body of said ink cartridge;
(S2) a step to insert a rubber cork into said open ink injecting hole;
(S3) a step to form an ink bubbles discharging hole on a predetermined position of a cover of said ink cartridge which covers said main body of said ink cartridge;
(S4) a step to slowly inject ink into said ink cartridge after inserting a needle of an ink injector into said rubber cork which is inserted into said ink injecting hole and; and
(S5) a step to extract said ink injector from said rubber cork after sealing said ink bubbles discharging hole formed on said cover with a predetermined sealing cork and.

2. The method as claimed in claim 1, the step (S5) to seal the ink bubbles discharging hole is performed at the time when the ink is fully refilled in the ink cartridge and it is discharged to the outside.
